(19) United States
(12) Patent Application Publication
(10) Pub. No.: US 2005/0049530 A1
(43) Pub. Date: Mar. 3, 2005

(54) Reclining massager system

(76) Inventor: Hakjin Kim, Diamond Bar, CA (US)

Correspondence Address: PARK & SUTTON LLP, 3255 WILSHIRE BLVD, SUITE 1110, LOS ANGELES, CA, 90010, US

(21) Appl. No.: 10/648,924

(22) Filed: Aug. 27, 2003

(51) Int. Cl. A61H 15/00

(52) U.S. Cl. 601/99; 601/100; 601/102; 601/116

(57) ABSTRACT

A reclining massager system comprises a base, a back support to place a user's back and neck thereon when the user is seated in the base. The back support has a cover, first and second ends with the first end rotatably connected to the base in a controllably reclining format. A rider makes a lengthwise reciprocal movement between the first and second ends of the back support, and a lifter liftedly engaged to the rider makes a forward reciprocal movement perpendicular to the lengthwise reciprocal movement. Massage bumps veiled by the cover and attached atop the lifter massage along the user's back and neck by the relative movements of the rider and lifter.

### BACKGROUND OF THE INVENTION

The invention relates generally to a massaging device. More particularly, the present invention relates to an improved reclining massager system capable of efficiently treating bodily malfunctions such as back pain and gastrointestinal weakness by applying a therapeutic massaging treatment along the back and neck of a patient resting on the system serving as a reclining chair whose massaging bumps are to massage along the patient's spinal cord and neck in a double reciprocation mode.

Conventional reclining chairs adopting spinal massaging mechanism are disclosed to employ a vertical or lengthwise reciprocation and massage balls attached to a mounting member that allows the massage balls to make the vertical reciprocation along a user's back and neck. A disadvantage of such conventional arts is an optimal combination of the lengthwise reciprocation and the pushing momentum of the massage balls toward the user's back. Such pushing momentum needs to be optimally controlled depending on individuals using a reclining massager.

For example, a slim woman with a back pain may require a stronger pushing momentum than normal and at the same time more easily feels pain as the massage balls apply to the back with the required strong momentum. A demand on the market is to apply controllability to pushing mechanism of the massage balls to demonstrate a steady and robust therapeutic effects while harmonizing the lengthwise reciprocation with the pushing momentum of the massage balls toward the user's back and neck.

### SUMMARY OF THE INVENTION

The present invention is contrived to overcome the conventional disadvantages. Accordingly, an object of the invention is to provide a reclining massager system serving as a reclining chair employing a therapeutic massaging mechanism. Another object is to employ a gear mechanism for a forwardly pushing of massage bumps to maximize combinational effects with a vertical or lengthwise reciprocation of massage bumps.

A further object is to improve product reliability and customer satisfaction by reliably synthesizing the lengthwise and a forward reciprocations of the massage bumps.

To achieve these and other objects, the reclining massager system according to the present invention comprises a base, a back support to place a user's back and neck thereon when the user is seated in the base. The back support has a cover, first and second ends of which the first end is rotatably connected to the base in a controllably reclining format. A rider makes a lengthwise reciprocal movement between the first and second ends of the back support, and a lifter is liftedly engaged to the rider so that the lifter makes a forward reciprocal movement perpendicular to the lengthwise reciprocal movement of the rider.

In this construction, massage bumps veiled by the cover and attached atop the lifter are provided to massage along the user's back and neck in accordance with the relative movements of the rider and lifter. The lifter comprises a roller gear engaged to and powered by a first motor where the first motor is fixed to the rider, a bump support having a top portion and a bottom portion where the massage bumps are mounted on the top portion, and an engagement body downwardly extending from a bottom portion of the bump support where a lower portion of the engagement body is releasably inserted in and fittingly supported by the rider. Here, an opening is formed through the engagement body to define inner walls, and one of the inner walls is configured to a rack gear so that the first roller gear is rollably engaged to the rack gear, whereby the roller gear rotation by the first motor enables the lifter to make the forward reciprocal movement.

Alternately, the lifter may include a bump support having a top portion and a bottom portion where the massage bumps are mounted on the top portion, and a gear unit including a bolt gear downwardly extending from the bottom portion of the bump support, an elongated nut type gear having a circular outer periphery, a first gear incorporated on and along the circular outer periphery, and a second gear engaged to the first gear and connected to a first motor attached to the rider. The bolt gear is releasably engaged in the nut type gear whose bottom end is rotatably attached to and supported by the rider, whereby the second gear rotation generates the first gear rotation and the subsequent rotation of the nut type gear enables the lifter to make the forward reciprocal movement in accordance with the releasable engagement of the bolt gear and the nut type gear.

In a preferred version, a pair of pulleys are linked by a rope and respectively mounted in the first and second ends of the back support, and a predetermined portion of the rope is fixedly attached to the rider so that the pulley rotation enables the rider to generate the lengthwise reciprocal movement. Also, guide rails are provided substantially parallel to the rope and between the first and second ends of the back support, and guide rollers attached to the rider are rollably fit in the guide rails to facilitate the lengthwise reciprocation of the rider.

For a better performance, a threaded shaft geared through the nut and rotatably engaged at the first and second ends of the back support to generate the lengthwise reciprocal movement of the rider where the rider has at least one nut fixed thereto. The massage bumps are partitioned to first and second pairs so that each pair bumps are aligned parallel to the direction of the rider reciprocation. Further, first and second bump holders propping and maintaining the first and second pair bumps, and the first and second bump holders are tapered toward each lower end thereof. A first engagement member is provided to rockingly engage the lower ends of the bump holders to the top portion of the lifter, and a second engagement member is provided to rollingly engage the massage bumps thereto. The massage bumps each include a heater and the heater is preferably a heating lamp generating heat and infrared rays. And, at least one of the massage bumps is fixed to the lifter and shaped in hemisphere.

Advantages of the present inventions are numerous. Most of all, the reclining massager system according to the present invention optimally combines a lengthwise reciprocation of massage bumps with a forwardly reciprocal movement for thereby maximizing massaging effects on the back and neck of a patient resting on the massager system.

Further, the combination of the double reciprocations results in a conspicuous therapeutic effects by realizing a virtually total back massaging while resting on the massager system. Also, the massager maximally synthesizes multiple reciprocations in the movement of the massage bumps in a therapeutic format, thereby enhancing product reliability and customer satisfaction.

Although the present invention is briefly summarized, the full understanding of the invention can be obtained by the following drawings, detailed description and appended claims.

### BRIEF DESCIPTION OF THE DRAWINGS

These and other features, aspects and advantages of the present invention will become better understood with reference to the accompanying drawings, wherein:

FIG. 1 is a construction view showing a reclining massager system according to the present invention;

FIG. 2 is a perspective view showing reciprocation mechanism of massage bumps in FIG. 1;

FIG. 3 is a perspective view showing a mechanism of forward reciprocation of the massage bumps in FIG. 1;

FIGS. 4A-4D are views showing forward reciprocations implemented in the present invention;

FIGS. 5A and 5B are views showing forward reciprocations in another embodiment of the present invention; and

FIG. 6 is a construction view showing a further embodiment of the present invention.

### DETAILED DESCRIPTION OF THE PREFERRED EMBODIMENTS

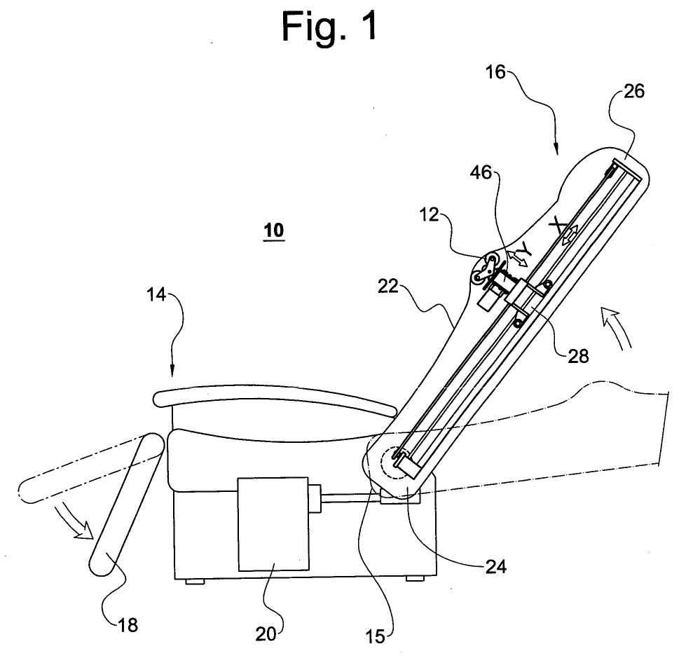

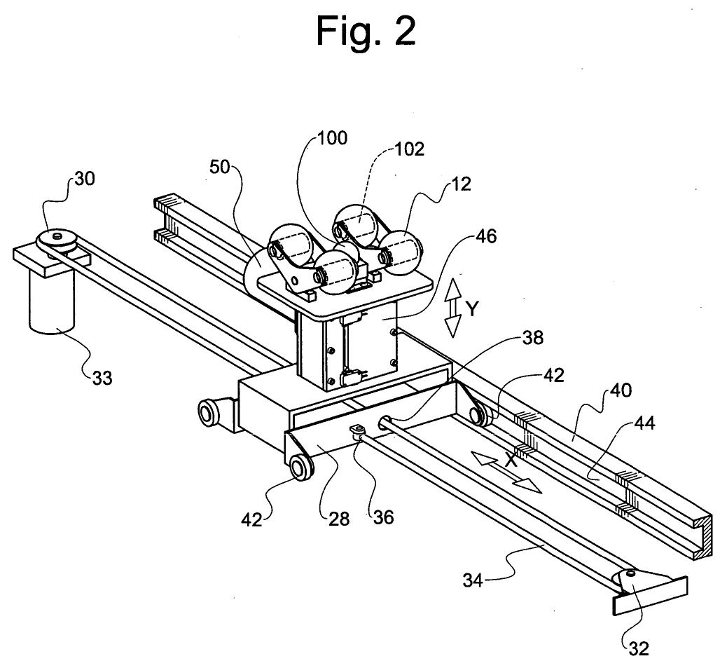

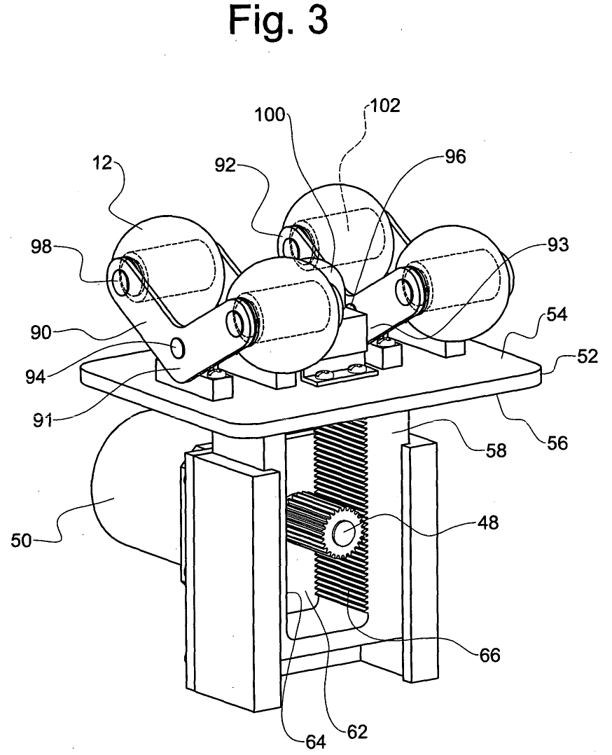

FIG. 1 shows a brief construction of a reclining massager system 10 according to a preferred embodiment of the present invention. FIG. 2 shows a mechanism of a lengthwise reciprocation and a forwardly reciprocal movement of massage bumps 12, and FIG. 3 shows a detailed mechanism of the forwardly reciprocal movement. As shown therein, the reclining massager system 10 includes a base 14 and a back support 16 to place a user's back and neck thereon when the user is seated in the base. The base 14 includes a calf support 18 that can be lifted as the back support 16 becomes in accordance with a user's manipulation of a controller 20.

The back support 16 has a cover 22, first and second ends 24, 26. The first end 24 is rotatably connected to the base 14 in a controllably reclining format. Specifically, the first end 24 serving as a lower end of the back support 16 is controllably connected to a rear portion 15 of the base 14. In this construction, a rider 28 is provided within the back support 16 to make a lengthwise reciprocal movement X between the first and second ends 24, 26 of the back support 16. In a preferred embodiment, a pair of pulleys 30, 32 powered by a pulley motor 33 are linked by a rope 34 and respectively mounted in the first and second ends 24, 26 of the back support 16. Here, a predetermined portion 36 of the rope 34 is fixedly attached to the rider 28 so that the pulley rotation enables the rider 28 to generate the lengthwise reciprocal movement X. In order to stabilize the lengthwise reciprocation X of the rider 28 it is recommended that the rider 28 reserves a hole 38 to receive the rope 34.

To further stabilize the lengthwise reciprocal movement X of the rider 28 in the pulley mechanism, the massager system 10 includes guide rails 40 provided substantially parallel to the rope 34 and between the first and second ends 24, 26 of the back support 16, and guide rollers 42 attached to the rider 28. Here, the guide rollers 42 are rollably fit in the guide rails 42 to facilitate the lengthwise reciprocation X of the rider 28. Specifically, the guide rollers 42 are housed within a side recess 44 formed along the guide rails 42.

A lifter 46 is liftedly engaged to the rider 28 so that the lifter 46 makes a forward reciprocal movement Y perpendicular to the lengthwise reciprocal movement X of the rider 28. The lifter 46 comprises a roller gear 48 engaged to and powered by a first motor 50 fixed to the rider 28, a bump support 52 having a top portion 54 and a bottom portion 56 where the massage bumps 12 are mounted on the top portion 54, and an engagement body 58 downwardly extending from a bottom portion 56 of the bump support 52.

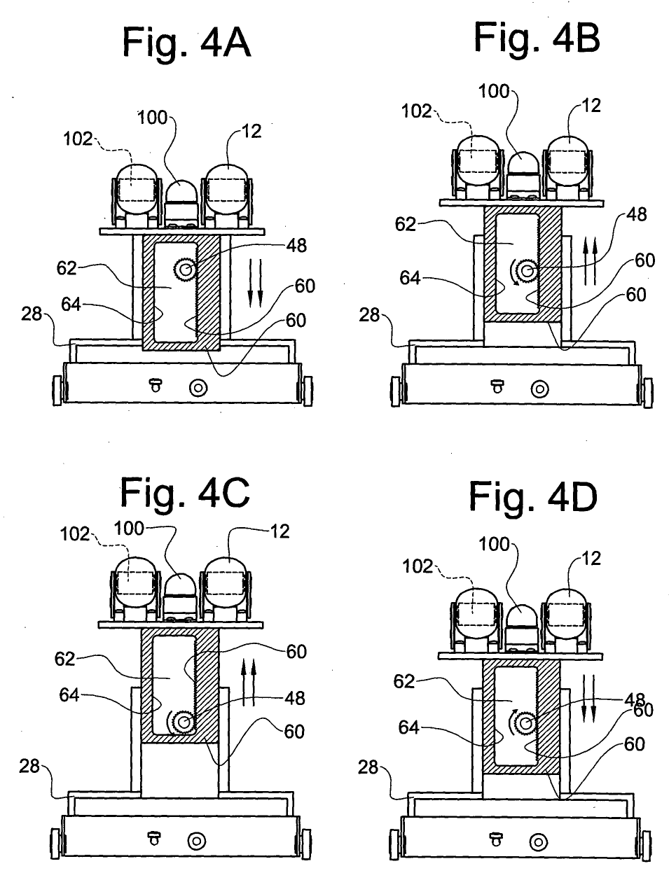

As shown in FIGS. 4A-4D, a lower portion 60 of the engagement body 58 is releasably inserted in and fittingly supported by the rider 28, and an opening 60 is formed through the engagement body 58 to define inner walls 64. One of the inner walls 64 is configured to a rack gear 66 so that the first roller gear 48 is rollably engaged to the rack gear 66, whereby the roller gear rotation by the first motor 50 enables the lifter 46 to make the forward reciprocal movement Y perpendicular to the lengthwise reciprocation X of the rider 28. That is, when the roller gear 48 engaged to the rack gear 66 of the engagement body 58 makes a clockwise rotation, the bump support 52 becomes lowered accordingly and the massage bumps 12 also becomes lowered subsequently. Whereas, a counterclockwise rotation of the roller gear 48 serves to raise the bump support 54 and subsequently the massage bumps 12 become raised. Accordingly, when the user rests on the massager system 10 with the back on the back support 16, the massage bumps 12 controllably apply to the back and neck of the user for massaging effects. Here, the pushing momentum of the massage bumps 12 toward the user's back and neck is adjustable by controlling the motor 50.

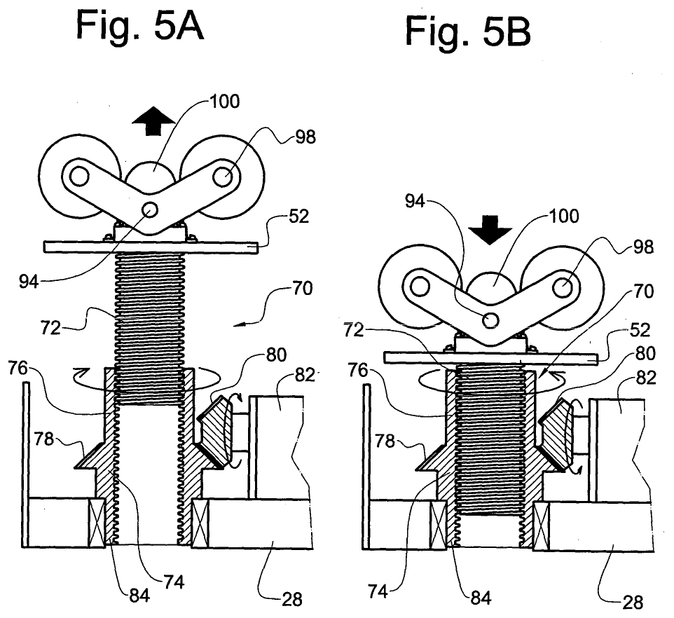

As further shown in FIGS. 5A and 5B, the lifter 46 implemented in an alternate mode includes a gear unit 70 including a bolt gear 72 downwardly extending from the bottom portion 56 of the bump support 52, an elongated nut type gear 74 having a circular outer periphery 76, a first gear 78 incorporated on and along the circular outer periphery 76, and a second gear 80 engaged to the first gear 78 and connected to a first motor 82 attached to the rider 28. In this construction, the bolt gear 72 is releasably engaged in the nut type gear 74 whose bottom end 84 is rotatably attached to and supported by the rider 28, whereby the second gear 80 rotation generates the first gear 78 rotation and the subsequent rotation of the nut type gear 74 enables the lifter 46 to make the forward reciprocal movement Y in accordance with the releasable engagement of the bolt gear 72 and the nut type gear 74.

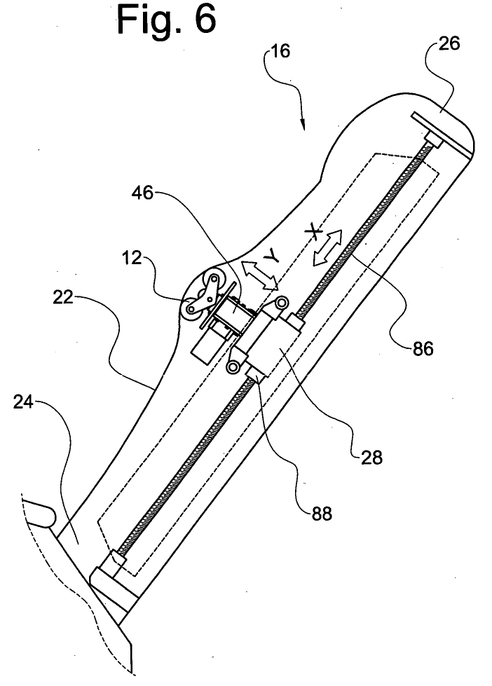

FIG. 6 shows another embodiment of the reclining massager system 10 where a threaded shaft 86 is employed for the lengthwise reciprocation X of the rider 28. In this construction, the rider 28 is preferably provided with at least one nut 88 fixed thereto so that the threaded shaft 86 is geared through the nut 88 and rotatably engaged at the first and second ends 24,26 of the back support 16 to generate the lengthwise reciprocal movement X of the rider 28 therealong.

Such double reciprocation mechanism X, Y upgrades therapeutic massaging effects of the massage bumps 12 to the user's back and neck. The massage bumps 12 are veiled by the cover 22 and attached atop the lifter 46 to massage along the user's back and neck in accordance with the relative movements of the rider 28 and lifter 46. Preferably, the massage bumps 12 are partitioned to first and second pairs so that each pair bumps are aligned parallel to the direction of the rider reciprocation X.

The first and second bump holders 90, 92 are provided to prop and maintain the first and second pair bumps, and the first and second bump holders 90, 92 are tapered toward each lower end 91, 93 thereof. A first engagement member 94 serves to rockingly engage the lower ends 91, 93 of the bump holders 90, 92 to the top portion 54 of the lifter 46. A second engagement member 98 serves to rollingly engage the massage bumps 12 thereto. At least one 100 of the massage bumps 12 is fixed to the lifter 46 without being hooked by a bump holder and shaped in hemisphere. When the bumps 12 are aligned parallel to each other by the bump holders 90, 92 the fixed bump 100 is centered among the bumps 12. The massage bumps 12 each include a heater 102, and the heater 102 is preferably a heating lamp generating heat and infrared rays. The massage bumps 12 may be shaped in a substantially spherical format.

As discussed above, an advantage of the present inventions is that the reclining massager system 10 optimally combines the lengthwise reciprocation X of massage bumps 12 with a forwardly reciprocal movement Y to maximize massaging effects on the back and neck of a patient resting on the massager system 10. Further, the combination of the double reciprocations X, Y results in a conspicuous therapeutic effects by realizing a virtually total back massaging while resting on the massager system 10. Also, the massager maximally synthesizes multiple reciprocations for the movement of the massage bumps in a therapeutic format, thereby enhancing product reliability and customer satisfaction.

Although the invention has been described in considerable detail, other versions are possible by converting the aforementioned construction. Therefore, the scope of the invention shall not be limited by the specification specified above and the appended claims.

1. A reclining massager system, comprising:
a) a base;
b) a back support to place a user's back and neck thereon when the user is seated in the base, wherein the back support has a cover, first and second ends, wherein the first end is rotatably connected to the base in a controllably reclining format;
c) a rider making a lengthwise reciprocal movement between the first and second ends of the back support;
d) a lifter liftedly engaged to the rider so that the lifter makes a forward reciprocal movement perpendicular to the lengthwise reciprocal movement of the rider; and
e) massage bumps veiled by the cover and attached atop the lifter to massage along the user's back and neck in accordance with the relative movements of the rider and lifter.

2. The reclining massager system of claim 1 wherein the lifter comprises:
a) a roller gear engaged to and powered by a first motor, wherein the first motor is fixed to the rider;
b) a bump support having a top portion and a bottom portion, wherein the massage bumps are mounted on the top portion; and
c) an engagement body downwardly extending from a bottom portion of the bump support, wherein a lower portion of the engagement body is releasably inserted in and fittingly supported by the rider, wherein an opening is formed through the engagement body to define inner walls, wherein one of the inner walls is configured to a rack gear so that the first roller gear is rollably engaged to the rack gear, whereby the roller gear rotation by the first motor enables the lifter to make the forward reciprocal movement.

3. The reclining massager system of claim 1 wherein the lifter comprises:
a) a bump support having a top portion and a bottom portion, wherein the massage bumps are mounted on the top portion; and
b) a gear unit including a bolt gear downwardly extending from the bottom portion of the bump support, an elongated nut type gear having a circular outer periphery, a first gear incorporated on and along the circular outer periphery, and a second gear engaged to the first gear and connected to a first motor attached to the rider, wherein the bolt gear is releasably engaged in the nut type gear whose bottom end is rotatably attached to and supported by the rider, whereby the second gear rotation generates the first gear rotation and the subsequent rotation of the nut type gear enables the lifter to make the forward reciprocal movement in accordance with the releasable engagement of the bolt gear and the nut type gear.

4. The reclining massager system of claim 1 wherein the massage bumps are partitioned to first and second pairs, wherein said each pair bumps are aligned parallel to the direction of the rider reciprocation.

5. The reclining massager system of claim 1 further comprising:
a) first and second bump holders propping and maintaining the first and second pair bumps, wherein the first and second bump holders are tapered toward each lower end thereof;
b) a first engagement member to rockingly engage the lower ends of the bump holders to the top portion of the lifter; and
c) a second engagement member to rollingly engage the massage bumps thereto.

6. The reclining massager system of claim 1 wherein the massage bumps each include a heater.

7. The reclining massager system of claim 6 wherein the heater is a heating lamp generating heat and infrared rays.

8. The reclining massager system of claim 1 wherein at least one of the massage bumps is fixed to the lifter and shaped in hemisphere.

9. A reclining massager system, comprising:
a) a base;
b) a back support to place a user's back and neck thereon when the user is seated in the base, wherein the back support has a cover, first and second ends, wherein the first end is rotatably connected to the base in a controllably reclining format;
c) a rider making a lengthwise reciprocal movement between the first and second ends of the back support;
d) a pair of pulleys linked by a rope and respectively mounted in the first and second ends of the back support, wherein a predetermined portion of the rope is fixedly attached to the rider so that the pulley rotation enables the rider to generate the lengthwise reciprocal movement;
e) a lifter liftedly engaged to the rider so that the lifter makes a forward reciprocal movement perpendicular to the lengthwise reciprocal movement of the rider; and
f) massage bumps veiled by the cover and attached atop the lifter to massage along the user's back and neck in accordance with the relative movements of the rider and lifter.

10. The reclining massager system of claim 9 further comprising:
a) guide rails provided substantially parallel to the rope and between the first and second ends of the back support; and
b) guide rollers attached to the rider, wherein the guide rollers are rollably fit in the guide rails to facilitate the lengthwise reciprocation of the rider.

11. The reclining massager system of claim 9 wherein the lifter comprises:
a) a roller gear engaged to and powered by a first motor, wherein the first motor is fixed to the rider;
b) a bump support having a top portion and a bottom portion, wherein the massage bumps are mounted on the top portion; and
c) an engagement body downwardly extending from a bottom portion of the bump support, wherein a lower portion of the engagement body is releasably inserted in and fittingly supported by the rider, wherein an opening is formed through the engagement body to define inner walls, wherein one of the inner walls is configured to a rack gear so that the first roller gear is rollably engaged to the rack gear, whereby the roller gear rotation by the first motor enables the lifter to make the forward reciprocal movement.

12. The reclining massager system of claim 9 wherein the lifter comprises:
a) a bump support having a top portion and a bottom portion, wherein the massage bumps are mounted on the top portion; and
b) a gear unit including a bolt gear downwardly extending from the bottom portion of the bump support, an elongated nut type gear having a circular outer periphery, a first gear incorporated on and along the circular outer periphery, and a second gear engaged to the first gear and connected to a first motor attached to the rider, wherein the bolt gear is releasably engaged in the nut type gear whose bottom end is rotatably attached to and supported by the rider, whereby the second gear rotation generates the first gear rotation and the subsequent rotation of the nut type gear enables the lifter to make the forward reciprocal movement in accordance with the releasable engagement of the bolt gear and the nut type gear.

13. The reclining massager system of claim 9 wherein the massage bumps are partitioned to first and second pairs, wherein said each pair bumps are aligned parallel to the direction of the rider reciprocation.

14. The reclining massager system of claim 9 further comprising:
a) first and second bump holders propping and maintaining the first and second pair bumps, wherein the first and second bump holders are tapered toward each lower end thereof;
b) a first engagement member to rockingly engage the lower ends of the bump holders to the top portion of the lifter; and
c) a second engagement member to rollingly engage the massage bumps thereto.

15. The reclining massager system of claim 9 wherein the massage bumps each include a heater.

16. The reclining massager system of claim 9 wherein the heater is a heating lamp generating heat and infrared rays.

17. The reclining massager system of claim 9 wherein at least one of the massage bumps is fixed to the lifter and shaped in hemisphere.

18. A reclining massager system, comprising:
a) a base;
b) a back support to place a user's back and neck thereon when the user is seated in the base, wherein the back support has a cover, first and second ends, wherein the first end is rotatably connected to the base in a controllably reclining format;
c) a rider making a lengthwise reciprocal movement between the first and second ends of the back support, wherein the rider has at least one nut fixed thereto;
d) a threaded shaft geared through the nut and rotatably engaged at the first and second ends of the back support to generate the lengthwise reciprocal movement of the rider;
e) a lifter liftedly engaged to the rider so that the lifter makes a forward reciprocal movement perpendicular to the lengthwise reciprocal movement of the rider; and
f) massage bumps veiled by the cover and attached atop the lifter to massage along the user's back and neck in accordance with the relative movements of the rider and lifter.

19. The reclining massager system of claim 18 wherein the lifter comprises:
a) a roller gear engaged to and powered by a first motor, wherein the first motor is fixed to the rider;
b) a bump support having a top portion and a bottom portion, wherein the massage bumps are mounted on the top portion; and
c) an engagement body downwardly extending from a bottom portion of the bump support, wherein a lower portion of the engagement body is releasably inserted in and fittingly supported by the rider, wherein an opening is formed through the engagement body to define inner walls, wherein one of the inner walls is configured to a rack gear so that the first roller gear is rollably engaged to the rack gear, whereby the roller gear rotation by the first motor enables the lifter to make the forward reciprocal movement.

20. The reclining massager system of claim 18 wherein the lifter comprises:
a) a bump support having a top portion and a bottom portion, wherein the massage bumps are mounted on the top portion; and
b) a gear unit including a bolt gear downwardly extending from the bottom portion of the bump support, an elongated nut type gear having a circular outer periphery, a first gear incorporated on and along the circular outer periphery, and a second gear engaged to the first gear and connected to a first motor attached to the rider, wherein the bolt gear is releasably engaged in the nut type gear whose bottom end is rotatably attached to and supported by the rider, whereby the second gear rotation generates the first gear rotation and the subsequent rotation of the nut type gear enables the lifter to make the forward reciprocal movement in accordance with the releasable engagement of the bolt gear and the nut type gear.

21. The reclining massager system of claim 18 wherein the massage bumps are partitioned to first and second pairs, wherein said each pair bumps are aligned parallel to the direction of the rider reciprocation.

22. The reclining massager system of claim 18 further comprising:
a) first and second bump holders propping and maintaining the first and second pair bumps, wherein the first and second bump holders are tapered toward each lower end thereof;
b) a first engagement member to rockingly engage the lower ends of the bump holders to the top portion of the lifter; and
c) a second engagement member to rollingly engage the massage bumps thereto.

23. The reclining massager system of claim 18 wherein the massage bumps each include a heater.

24. The reclining massager system of claim 23 wherein the heater is a heating lamp generating heat and infrared rays.

25. The reclining massager system of claim 18 wherein at least one of the massage bumps is fixed to the lifter and shaped in hemisphere.
